(19) United States
(12) Patent Application Publication
(10) Pub. No.: US 2011/0275351 A1
(43) Pub. Date: Nov. 10, 2011

(54) MOBILE VOICEMAIL APPLICATION

(75) Inventors: Artur TYLOCH, Warsaw (PL); Istvan NAGY, Budapest (HU); Dmytro ZAYATS, Arlington Heights, IL (US); Attila INCZE, Budapest (HU); Naheed VORA, Santa Clara, CA (US); Maarten ECTORS, Madrid (ES)

(73) Assignee: NOKIA SIEMENS NETWORKS OY, Espoo (FI)

(21) Appl. No.: 12/776,821

(22) Filed: May 10, 2010

(51) Int. Cl. H04M 11/10

(52) U.S. Cl. 455/413

(57) ABSTRACT

An arrangement is provided for detecting that a called party is not (or is not able) to accept an incoming call, such that a voicemail application should be initiated. In response to this detection, a premium voicemail service is initiated, for example by a SIP server that does not typically form part of the mobile operator of the called party. The premium voicemail service selects one of a number of available voicemail services, typically dependent on the identity of the called party and/or the calling party and provides that voicemail service. The voicemail service(s) offered by the premium voicemail service are user-definable. For example, the user may be able to purchase a particular voicemail service, modify and existing voicemail service and/or design a voicemail service.

The present invention is directed to a voicemail application. In particular, the invention is direct to voicemail applications for use with a mobile telecommunications operator.

Voicemail applications are well known in the field of mobile telecommunications. Voicemail applications allow an incoming call to be diverted to a voicemail program to enable the calling party to leave a message. The calling party may be diverted to voicemail, for example, because the called party is unavailable or because the called party chooses not to accept the incoming call.

Voicemail applications for mobile communication devices are typically provided by mobile operators. Such operators provide voicemail services for large numbers of customers. Such services cannot readily be customised by end users. Typically, a voicemail service allows an end user to record a message to be played to the calling party asking them to leave a message, but does not allow any further customisation.

Thus, existing voicemail services lack flexibility and cannot be readily modified by end users.

The present invention seeks to address at least some of the problems outlined above.

The present invention provides a method comprising: receiving an indication from a mobile telecommunications operator that a called device (e.g. a mobile communications device) is not accepting (or is not able to accept) a call from a calling party; and initiating a voicemail application in response to the detecting step.

The present invention also provides an apparatus, such as a server (e.g. a SIP server) or a voicemail application (or an apparatus providing a voicemail application), the apparatus comprising: a first input for receiving an indication from a mobile telecommunications operator that a called party (e.g. a mobile communication device of the called party) is not accepting (or is not able to accept) a call from a calling party; and a processor adapted to initiate a user-defined voicemail application in response to the detecting step.

Accordingly, an arrangement is provided for detecting that a called party is not (or is not able) to accept an incoming call, such that a voicemail application should be initiated. In response to this detection, a premium voicemail service (not the service typically provided by the operator) is initiated, for example by a SIP server that does not typically form part of the mobile operator of the called party. The premium voicemail service may select one of a number of available voicemail services, for example, dependent on the identity of the called party and/or the calling party and provides that voicemail service. The voicemail service(s) offered by the premium voicemail service are typically user-definable. For example, the user may be able to purchase a particular voicemail service, modify an existing voicemail service and/or design a voicemail service.

In one form of the invention, the step of receiving said indication from a mobile telecommunications operator that a called device is not accepting a call from a calling party comprises receiving a call divert message from a telecommunications operator for the called party.

Initiating the said voicemail application may include the selection of one of a plurality of available voicemail modules of the voicemail application. Each voicemail module is typically a complete, functioning voicemail application. Accordingly, the voicemail application can provide a plurality of complete, functioning voicemail modules, wherein one of those modules is selected for use each time the voicemail application is invoked. An apparatus of the invention may comprise a processor adapted to perform said selection of one of a plurality of available voicemail modules.

Said one of said plurality of available voicemail modules selected in said selecting step may be dependent on one or more characteristics of the calling party. For example, characteristics such as identity and presence information (e.g. status) may be used. Alternatively, or in addition, said one of said plurality of available voicemail modules selected in said selecting step may be dependent on one or more characteristics of the called party (such as identity or presence information).

At least some of said voicemail modules may be selected from a plurality of possible voicemail services. (For example, a voicemail service can be bought from a third party, e.g. from a web site.) The ability to buy and sell voicemail modules increases the flexibility provided to the user. The voicemail modules may be obtain from multiple different sources, e.g. some may be designed by the user, some may be provided by an operator and/or some may be bought from a third party.

The said voicemail application (or individual modules of the voicemail application) may be modifiable by the user. The apparatus of the invention may provide a processor enabling the user to modify the voicemail application (or modules of the voicemail application).

The said voicemail application (or individual modules of the voicemail application) may be provided by the user. The apparatus of the invention may include an input for receiving one or more user-defined voicemail applications or voicemail modules. The voicemail application (or individual modules of the voicemail application) may be designed by the user (perhaps using the drag and drop method described herein).

The present invention also provide a voicemail application comprising: a first processor adapted to receive an indication from a mobile telecommunications operator that a called party is not accepting a call from a calling party; and a second processor (which may be the same physical processor as the first processor) adapted to initiate a voicemail module in response to said indication.

The present invention further provides a computer program comprising: code (or some other means) for receiving an indication from a mobile telecommunications operator that a called device (e.g. a mobile communications device) is not accepting (or is not able to accept) a call from a calling party; and code (or some other means) for initiating a voicemail application in response to the detecting step. The computer program may be a computer program product comprising a computer-readable medium bearing computer program code embodied therein for use with a computer.

Exemplary embodiments of the invention are described below, by way of example only, with reference to the following numbered schematic drawings.

FIG. 1 shows an exemplary system in which the present invention may be used.

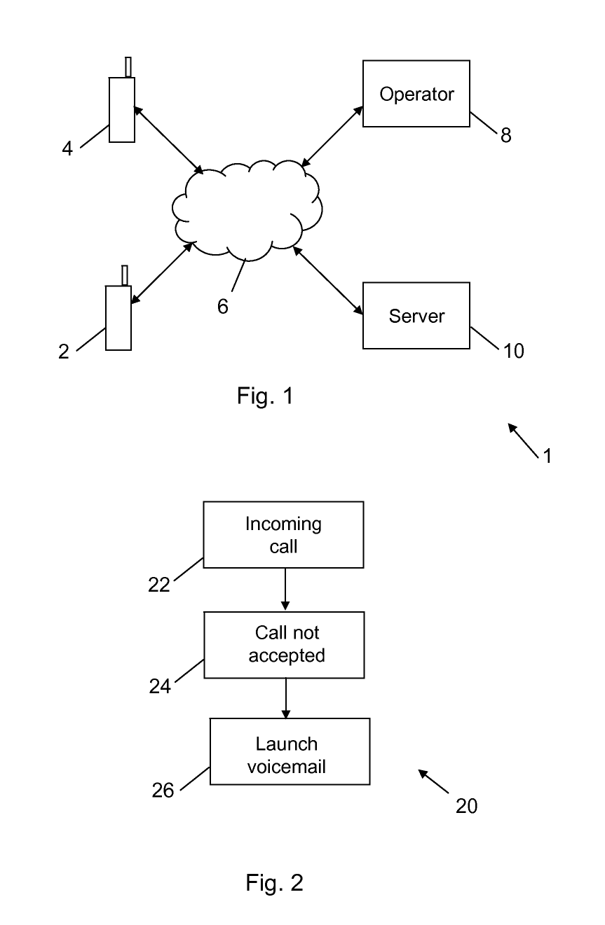

FIG. 2 is a flow chart showing an algorithm in accordance with an aspect of the present invention.

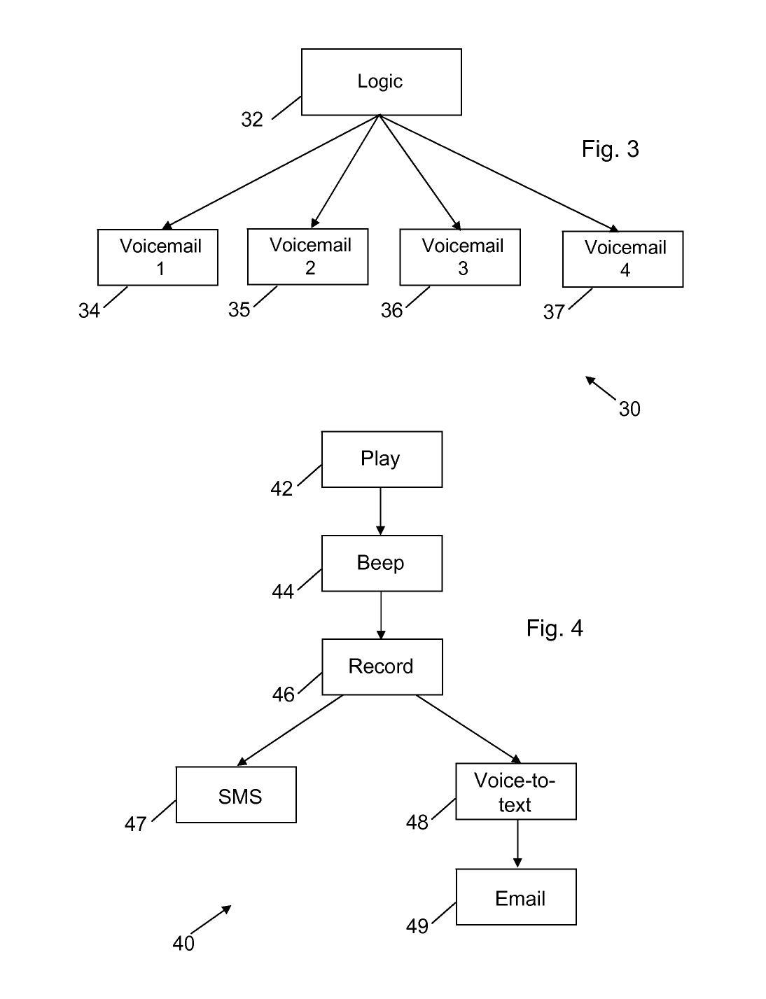

FIG. 3 is a block diagram of an algorithm in accordance with an aspect of the present invention.

FIG. 4 is a flow chart showing an algorithm in accordance with an aspect of the present application.

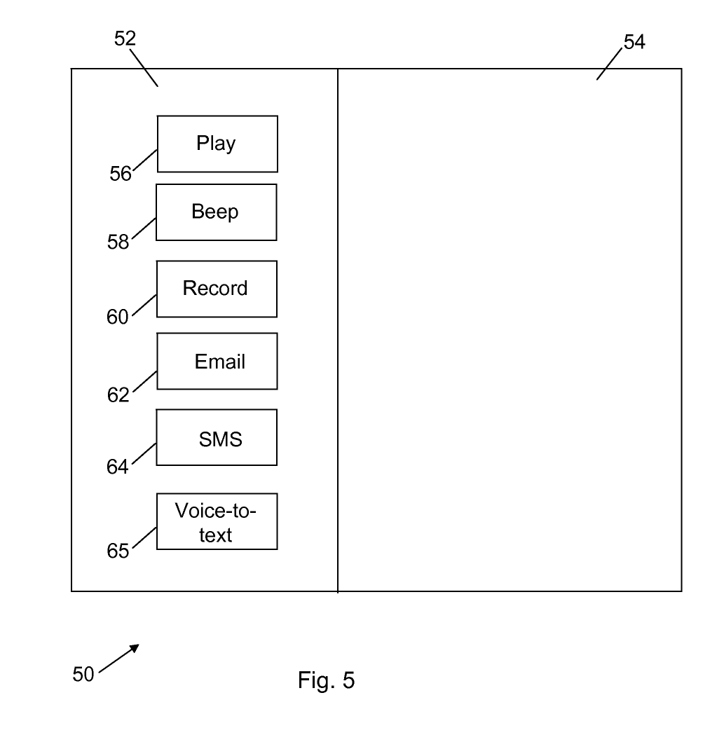

FIG. 5 shows an exemplary graphical user interface for a voicemail application generator.

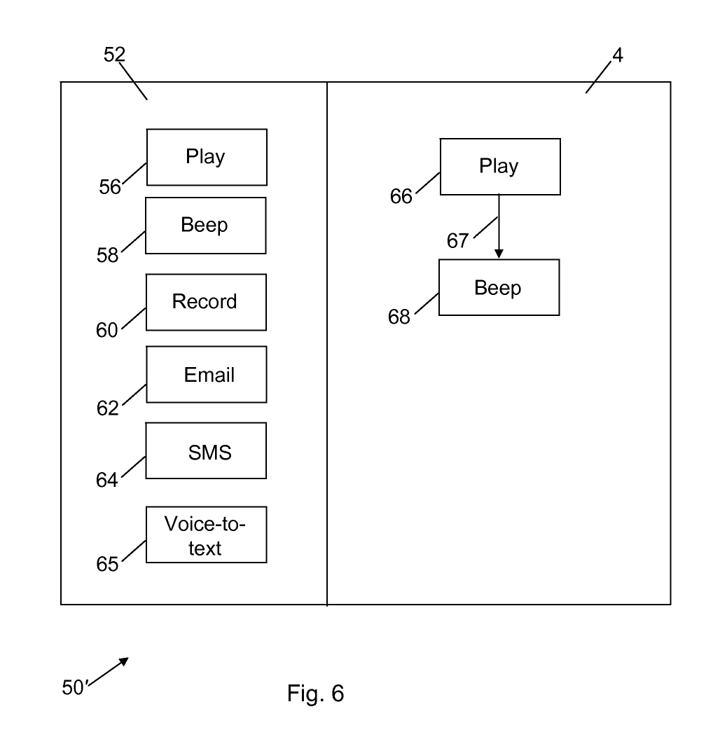

FIG. 6 shows the graphical use interface of FIG. 5 as used to generate a part of a voicemail application.

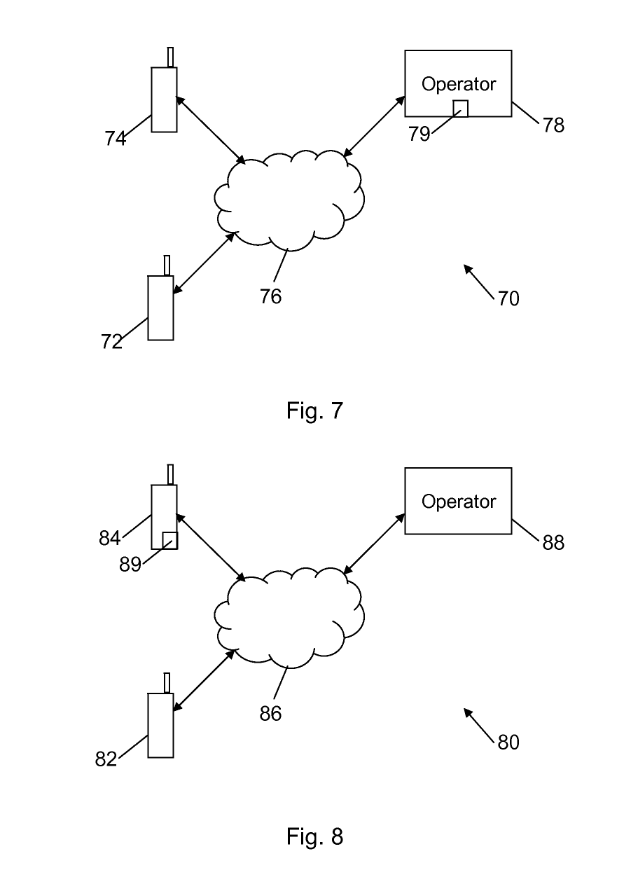

FIG. 7 is a block diagram of an exemplary system in accordance with an aspect of the present invention.

FIG. 8 is a block diagram of an exemplary system in accordance with an aspect of the present invention.

FIG. 1 shows an exemplary system, indicated generally by the reference numeral 1, in accordance with an aspect of the present invention. The system 1 comprises a mobile communication device of a calling party 2, a mobile communication device of a called party 4, a mobile telecommunications network 6, a mobile telecommunications operator 8 and a server 10. The calling party 2 uses the mobile telecommunications network 6 to attempt to call the called party 4.

FIG. 2 is a flow chart showing an algorithm, indicated generally by the reference numeral 20, in accordance with an aspect of the present invention. The algorithm 20 starts at step 22 where a call is made (or attempted to be made) from the calling party 2 to the called party 4.

Next, at step 24, an indication is given that the call will not be (or is not) accepted. This may, for example, be because the called party is unavailable (perhaps because the mobile communications device 4 is switched off). Alternatively, the called party may refuse to accept the call. In any event, at step 24, the called party does not answer the call. This step usually triggers the activation of a voicemail service of the operator 8.

Next, at step 26, a voicemail service of the present invention is initiated. The voicemail service is activated by the server 10 and can be used to replace (or possibly work alongside) the normal voicemail service provided by the operator 8.

The server 10 may monitor communications sent to and/or from the mobile communication device of the called party 4. In this way, the server 10 can determine when the voicemail service provided by the server 10 should be initiated (thereby implementing the step 24). Alternatively, the server 10 may simply await an indication of the operator 8 that a voicemail application should be initiated. In one embodiment of the invention, the server 10 is a session initiation protocol (SIP) server. For example, in one form of the invention, the called party 4 needs to instruct the operator (in advance) to redirect voicemail services to the server 10. Typically, the operator 8 implements voicemail services by diverting calls to its own voicemail service. This functionality can be used to arrange for the diversion to be made to the voicemail service provided by the server 10 rather that to the voicemail service provided by the operator 8.

FIG. 3 is a block diagram of an algorithm, indicated generally by the reference numeral 30, of an exemplary embodiment of the voicemail service of the present invention. The algorithm 30 starts after step 26 of the algorithm 20 described above.

The exemplary form of the voicemail service shown in FIG. 3 includes a number of different voicemail services that can be implemented, depending on one or more inputs received at the server 10. By way of example, a first voicemail service 34, a second voicemail service 35, a third voicemail service 36 and a fourth voicemail server 37 are shown in FIG. 3. Of course, more or fewer than four voicemail services could be provided. Indeed, in some forms of the invention only one voicemail service is provided.

The algorithm 30 starts at step 32 where a service logic (provided by the server 10) determines which of the voicemail services 34, 35, 36 and 37 should be used. In one form of the invention, the identity of the calling party 2 and/or the identity of the called party 4 may be used to select the voicemail application that should be used. For example, different voicemail accounts may be setup for different calling parties, or different classes of calling parties. Thus, a called party's wife may be diverted to the first voicemail application 34, the called party's personal friends may be diverted to the second voicemail application 35 and the called party's work colleagues may be diverted to the third voicemail application 36. All other callers may be diverted to the fourth voicemail application 37.

Alternatively, or in addition, to using the calling party's identity to select an appropriate voicemail application, the called party's presence information may be used. For example, if the called party's presence status is “in a meeting”, then a voicemail application relevant to that status may be selected. Such an application may indicate that the called party is temporarily unavailable, but should be available soon. If the called party's presence status is “on vacation” and the calling party is a work colleague (indicated, for example, by the calling party's identity data), the selection voicemail application might suggest that the calling party contacts one of the called party's colleagues for further assistance. If the called party's presence status is “on vacation” and the calling party is a personal friend, then an appropriate voicemail application could be selected indicating that the called party is on vacation but he can be contacted at a particular hotel in cases of emergency.

Of course, other selection mechanism, making use of one or more selection criteria, could be provided. As indicated above, some selection data could be obtained from the calling party and some selection data could be obtained from the called party. Alternatively, or in addition, some selection data could be obtained from sources other that the called and/or calling parties, e.g. time of day or day of the week. For example, a call received on a working day might be handled differently to a call handled on a weekend and/or when the called party is on vacation. The skilled person will be able to think of many suitable selection algorithms.

One of the voicemail services 34, 35, 36 and 37 may be designated as a default voicemail service. Thus, if the service logic 32 does not determine that one of the other voicemail services should be selected, then the default service is used. The default service might, for example, be used if one or more of the calling party 2 and the called party 4 does not have a specific voicemail application assigned to it.

FIG. 4 is a flow chart showing an algorithm, indicated generally by the reference numeral 40, in accordance with an aspect of the present application. The flow chart 40 shows an exemplary voicemail application that might be provided by the server 10.

The algorithm 40 starts at step 42, where a message is played. The message might ask the calling party to leave a message. The message played at the step 42 may be provided as an audio file. The algorithm 40 may provide a file location for the audio file and, in some forms of the invention, the called party 4 (or a third party) may be able to change the file location of the audio file in order to change the message that is played. Alternatively, or in addition, the called party or a third party may be able to modify or replace the audio file itself.

Next, at step 44, a “beep” message is played. The beep may simply be an audible beep played to the calling party to indicate that a message should now be left. As with the step 42, the step 44 may include a reference to an audio file providing the beep message. As with the message played at step 42, the beep message could be modified, or the file location for the beep message could be modified.

The algorithm 40 then moves to step 46, which is a “record” step. At step 46, a message can be left by the calling party and that message is recorded.

Once the record step has been completed, the algorithm 40 divides in two, moving to both step 47 and 48.

At step 47 of the algorithm 40, an SMS message is sent to the called party informing them that a voicemail message has been left. The SMS message sent at step 48 might provide instructions of how the called party can retrieve the message. This branch of the algorithm 40 terminates once the step 47 has been completed.

At step 48 of the algorithm 40, a voice-to-text algorithm is applied to the message recorded at the record step 46 in order to transcribe any message left by the calling party. The algorithm 40 then moves to step 49, where the message transcribed at step 48 is placed into an email message, and that email message is sent to an email account of the called party. This branch of the algorithm 40 terminates once the step 49 has been completed.

The algorithm 40 is one of many voicemail algorithms that could be implemented by the server 10 and is provided by way of example only.

The voicemail applications 34, 35, 36 and 37 that are provided by the voicemail application 10 may be implemented in many different ways. For example, one or more of the voicemail applications might be implemented by being coded by a computer programmer (who may or may not be the called party). Alternatively, one or more of the voicemail applications might be purchased by an end user. In some forms of the invention, the entire voicemail application may be bought. In other forms of the invention, one or more of the voicemail applications 34, 35, 36 and 37 may be bought with others being provided or obtained in other ways. Thus, the present invention can provide a great deal of flexibility.

In a further alternative, one or more of the voicemail applications 34, 35, 36 and 37 may be generated by an end user (or a third party) as described below with reference to FIGS. 5 and 6.

FIG. 5 shows an exemplary graphical user interface for a voicemail application generator, indicated generally by the reference numeral 50, in accordance with an aspect of the present invention.

The user interface 50 comprises a first panel 52 and a second panel 54. The first panel 52 includes a number of elements that can be used to define a voicemail application. The second panel 54 is used to define and display the voicemail application (as discussed further below).

The elements shown in the panel 52 of FIG. 5 are a play icon 56, a beep icon 58, a record icon 60, an Email icon 62, an SMS icon 64 and a voice-to-text icon 65. Many other icons could be provided, including an Instant Messaging icon or a text-to-voice icon. Icons may be provided to forward messages to a user's social network application. Icons could be provided that relate to non-voicemail related applications, such as a location-based-services module. The skilled person will be able to think of many more such icons that could be provided.

The icons shown in the panel 52 are building blocks that can be used to build a voicemail application. In order to define a voicemail application, a user selects one of the icons and places an instance of that icon in the panel 54. The user places several icons in the panel and the joins the icons together (using an arrow) to generate an algorithm.

By way of example, FIG. 6 shows a graphical user interface indicated generally by the reference numeral 50′. The graphical user interface 50′ includes the features of the graphical user interface 50, and additionally includes part of an exemplary voicemail application in the second panel 54. Thus, the graphical user interface 50′ includes the icons 56, 58, 60, 62, 64 and 65 in the first panel 52. In addition, the graphical user interface 50′ includes (in the second panel 54) an instance of the play icon 56 (shown as icon 66 in the second panel) and an instance of the beep icon 58 (shown as icon 68 in the second panel). The play icon 66 and beep icon 68 are joined by an arrow 67 that indicates that the algorithm shown starts at icon 66 and then moves to icon 68.

In this way, the start of the algorithm 40 described above with reference to FIG. 4 has been generated.

Each of the icons shown in the first panel 52 of the user interface may have computer code associated with it. The computer code may be a routine that can be called to implement the functionality of the module. Accordingly, when the user interface 50 is used to generate a voicemail application, the voicemail application can be implemented by calling the routine associated with the relevant icon when indicated by the user-defined application.

FIGS. 7 and 8 are block diagrams of exemplary systems in accordance with an aspect of the present invention. The systems shown in FIGS. 7 and 8 are similar to the system 1 described above, but the location of the voicemail application is different in each case.

FIG. 7 shows a system, indicated generally by the reference numeral 70 comprising a communication device of a calling party 72, a communication device of a called party 74, a telecommunications network 76 and a telecommunications operator 78. The telecommunications operator includes a voicemail application 79 that is similar to the voicemail application provided by the server 10 described above. Thus, the system 70 differs from the system 1 in that the voicemail application is provided as part of the operator, rather that as a separate module.

FIG. 8 shows a system, indicated generally by the reference numeral 80 comprising a communication device of a calling party 82, a communication device of a called party 84, a telecommunications network 86 and a telecommunications operator 88. The called party includes a voicemail application 89 that is similar to the voicemail applications 10 and 78 described above. Thus, the system 80 differs from the systems 1 and 70 in that the voicemail application is provided as part of the called party.

In the examples described above, both the calling party and the called party typically make use of mobile communication devices. This is not essential to all embodiments of the present invention. In the present invention, the telecommunications network 6 is a mobile telecommunications network and the operator 8 provides mobile telecommunications services. The called party 4 typically uses a mobile communication device, but this is not essential (for example, any device that can interface with the mobile telecommunications network 6 could be used). The calling party 2 may use a mobile communication device or any other device that can interface with the network 6.

The embodiments of the invention described above are illustrative rather than restrictive. It will be apparent to those skilled in the art that the above devices and methods may incorporate a number of modifications without departing from the general scope of the invention. It is intended to include all such modifications within the scope of the invention insofar as they fall within the scope of the appended claims.

1. A method comprising:
receiving an indication from a mobile telecommunications operator that a called device is not accepting a call from a calling party; and
initiating a voicemail application in response to said indication.

2. A method as claimed in claim 1, wherein the step of receiving said indication from a mobile telecommunications operator that a called device is not accepting a call from a calling party comprises receiving a call divert message from a telecommunications operator for the called party.

3. A method as claimed in claim 1, wherein initiating said voicemail application includes the selection of one of a plurality of available voicemail modules of the voicemail application.

4. A method as claimed in claim 3, wherein said one of said plurality of available voicemail modules selected in said selecting step is dependent on the identity of the calling party.

5. A method as claimed in claim 3, wherein said one of said plurality of available voicemail modules selected in said selecting step is dependent on presence information of the called party.

6. A method as claimed in claim 1, wherein said voicemail application is selected from a plurality of possible voicemail services.

7. A method as claimed in claim 1, wherein said voicemail application is modifiable by the user.

8. A method as claimed in claim 1, wherein said voicemail application is provided by the user.

9. An apparatus comprising:
a first input for receiving an indication from a mobile telecommunications operator that a called party is not accepting a call from a calling party; and
a first processor adapted to initiate a voicemail application in response to said indication.

10. An apparatus as claimed in claim 9, wherein the processor is adapted to select one of a plurality of possible voicemail modules.

11. An apparatus as claimed in claim 10, wherein the selection of said one of said plurality of possible voicemail modules is dependent on a characteristic of the calling party.

12. An apparatus as claimed in claim 10, wherein the selection of said one of said plurality of possible voicemail modules is dependent on a characteristic of the called party.

13. An apparatus as claimed in claim 9, further comprising a second input for receiving a user-defined voicemail application.

14. An apparatus as claimed in claim 9, further comprising a second processor adapted to enable the user to modify said voicemail application.

15. An apparatus as claimed in claim 9, wherein the apparatus forms a part of the mobile communication device of the called party.

16. An apparatus as claimed in claim 9, wherein the apparatus forms a part of the mobile telecommunications operator.

17. An apparatus as claimed in claim 9, further comprising a second input and a second output for communicating with the called party and/or the mobile telecommunications operator.

18. A voicemail application comprising:
a first processor adapted to receive an indication from a mobile telecommunications operator that a called party is not accepting a call from a calling party; and
a second processor adapted to initiate a voicemail module in response to said indication.

19. A computer program product comprising:
means for receiving an indication from a mobile telecommunications operator that a called device is not accepting a call from a calling party; and
means for initiating a voicemail application in response to the detecting step.
